(19) United States
(12) Patent Application Publication
(10) Pub. No.: US 2005/0044429 A1
(43) Pub. Date: Feb. 24, 2005

(54) Resource utilization mechanism for microprocessor power management

(75) Inventors: Darius D. Gaskins, Austin, TX (US); G. Glenn Henry, Austin, TX (US)

Correspondence Address: HUFFMAN LAW GROUP, P.C., 1832 N. CASCADE AVE., COLORADO SPRINGS, CO, 80907-7449, US

(73) Assignee: IP-First LLC, Freemont, CA (US)

(21) Appl. No.: 10/646,988

(22) Filed: Aug. 22, 2003

(51) Int. Cl. G06F 1/26

(52) U.S. Cl. 713/300

(57) ABSTRACT

A microprocessor apparatus is provided including multiple functional units, some of which can enter a power reduction mode to decrease overall power consumption when needed. The functional units generate respective activity signals to indicate the level of activity of each of the functional units. The activity outputs are monitored by utilization assessment logic to determine a current total power consumption value for the microprocessor. The microprocessor is capable of successively entering a series of power reduction modes when the current total power consumption value is greater than a threshold power value of a specified power profile.

### BACKGROUND OF THE INVENTION

1. Field of the Invention

This invention relates in general to the field of power management in microprocessor systems, and more particularly to a method and apparatus for controlling resource utilization in a microprocessor for the purpose of managing the power consumption thereof.

2. Description of the Related Art

Managing the power consumption of modern computer systems is an important design consideration. This is especially true in the design of so-called laptop and notebook computer systems where battery life is a significant issue for users who operate their machines in the portable or undocked mode. Environmental concerns have also been known to drive designers to provide techniques for reducing power consumption.

One way to reduce power consumption in a computer system is to provide multiple power schemes such as is done in the Microsoft WINDOWS™ XP operating system. These power schemes include for example 1) Home/Office Desk 2) Portable/Laptop 3) Presentation 4) Always On 5) Minimal Power Management and 6) Maximum Battery. In each of these schemes, power to various parts of the computer system is reduced after selected amounts of time have transpired from the last keyboard input or other input. For example, in the Portable/Laptop mode (when the computer system is running on batteries) the monitor is turned off after 15 minutes of system inactivity, the hard disk is turned off after five minutes, system standby is entered after 15 minutes, and system hibernation commences after two hours of system inactivity.

Rather than turning off various components within a computer system, another technique that is employed for reducing power consumption in a computer is to control the power consumption of the microprocessor around which the computer system is built. One way to control the power consumption of a microprocessor is to change its internal clock frequency. Another related way of controlling processor power consumption is to additionally change the voltage at which the processor operates. For example, the amount of power that a given microprocessor is consuming can be markedly decreased by lowering its internal (i.e., core logic) clock frequency and commensurately decreasing its core voltage. Yet today, both of these microprocessor power management techniques rely upon external inputs to the microprocessor to indicate that the microprocessor is consuming too much power.

In many instances, the operating system employed by the computer system functions dynamically assesses power utilization by the processor. This is accomplished by monitoring the particular type of user program that is currently executing on the microprocessor, and then coarsely estimating the amount of processor power consumption based upon a knowledge of the types of operations that predominate in that user program. For example, a video processing program (e.g., an MPEG decoder) performs a significant number of single-instruction/multiple-data (SIMD) instructions that rely heavily upon certain functional units within the processor. Therefore, with a high-level knowledge of the microprocessor's internal architecture, the operating system can make a calculated guess of the amount of processor power consumed when executing a particular user application. If that estimated power consumption is relatively low, then there is no need to decrease processor performance. However, if a particular user application is estimated to consume more than a predetermined amount of power consumption, then the operating system can instruct the processor to decrease processor performance in order to commensurately reduce power consumption. As alluded to above, one set of techniques for decreasing performance as a way to decrease power consumption is to decrease core operating frequency, or to decrease both core operating frequency and core voltage. Such an approach to power management employs a relatively low number of power down steps or states and is inherently coarse.

Many modern computers adhere to the Advanced Configuration and Power Interface (ACPI) specification to enable the operating system to direct motherboard device configuration and power management of both devices and entire systems. ACPI is the main element of Operating System-directed configuration and Power Management (OSPM) in most present day personal computers. In short, ACPI provides for a processor with multiple processor power states controlled by the operating system. But the number of power states that are provided via ACPI is limited to the same degree as the power scheme techniques described above.

In applications where the life span of a system relies totally on the amount of power that is consumed by that system, the above-noted techniques for power management become disadvantageous. For instance, managing the power consumption of several hundred microprocessing elements within a deep space probe could extend the life or range of the probe to the extent that additional or extended experiments could be performed. But present day power management techniques have fully exploited the capabilities of current microprocessors to estimate and mange power consumption. Because they rely upon external sense mechanisms to coarsely infer the amount of power that is being consumed, these microprocessors provide a commensurate number of coarse power management steps which are directed by operating system controls. Present day microprocessors do not provide an accurate means for managing power consumption in such a manner that meaningful feedback is provided from functional units within.

Therefore, what is needed is a microprocessor in which the utilization of power by individual functional units within is determined to a fine degree of resolution so that power consumption can be more accurately controlled and managed.

### SUMMARY OF THE INVENTION

In accordance with one embodiment of the present invention, a processor is provided including a plurality of functional units each having an activity output for indicating when a respective functional unit is enabled. The processor also includes utilization assessment logic, coupled to the activity outputs of the functional units, for assessing activity thereof to determine a current total power consumption value for the processor. The processor further includes power control logic, coupled to the utilization assessment logic, for comparing the current total power consumption value with a threshold power value included in a selected power profile. The processor still further includes a power consumption controller, coupled to the power management logic and the functional units, for engaging one of a plurality of power reduction modes if the current total power consumption value exceeds a threshold power value of a selected power profile.

In accordance with another embodiment of the present invention, a processor is provided which includes a plurality of functional units each having an activity output for indicating when the respective functional unit is active. The processor further includes utilization assessment logic, coupled to the activity outputs of the functional units, for assessing activity thereof to determine a current total power consumption value for the processor. The processor also includes power control logic, coupled to the utilization assessment logic, for comparing the current total power consumption value with a threshold power value included in a selected power profile, The processor still further includes a power consumption controller, coupled to the power control logic, for disabling a first functional unit of the plurality of functional units to reduce the processor's power consumption if the current total power consumption value exceeds the threshold power value of the selected power profile.

In accordance with yet another embodiment of the present invention, a processor is provided which includes a plurality of functional units each having an activity output for indicating when a respective functional unit is enabled. The processor further includes power management logic, coupled to the activity outputs of the functional units, for assessing the activity of individual functional units to determine a current total power consumption value for the processor. The processor also includes a power consumption controller, coupled to the power management logic and the functional units, for disabling at least one of the functional units, if the current total power consumption value exceeds a threshold power value of a selected power profile.

A method is also disclosed for operating the described processor which includes a plurality of functional units. The disclosed method includes selecting a power profile for the processor from a plurality of power profiles each having a respective threshold power value associated therewith, thus providing a selected power profile. The method also includes assessing activity by individual functional units of the processor to determine a current total power consumption value for the processor. The method further includes comparing the current total power consumption value with the threshold power value of the selected power profile. The method still further includes engaging one of a plurality of power reduction modes if the current total power consumption value exceeds the threshold power value of the selected power profile.

Another embodiment of the method includes selecting a power profile for the processor from a plurality of power profiles each having a respective threshold power value associated therewith, thus providing a selected power profile. The method also includes assessing activity by individual functional units of the processor to determine a current total power consumption value for the processor. The method further includes comparing the current total power consumption value with the threshold power value of the selected power profile. The method still further includes disabling a first functional unit of the plurality of functional units to reduce the processor's power consumption if the current total power consumption value exceeds the threshold power value of the selected power profile.

The disclosed processor advantageously achieves reduced power consumption. The amount of power conservation exhibited by the processor is selectable according to user specified power profiles. Other features and advantages of the present invention will become apparent upon study of the remaining portions of the specification and drawings.

### BRIEF DESCRIPTION OF THE DRAWINGS

These and other objects, features, and advantages of the present invention will become better understood with regard to the following description, and accompanying drawings where:

FIG. 1 is a block diagram of a conventional computer system;

FIG. 2 is a block diagram of a microprocessor according to the present invention;

FIG. 3 is a detailed block diagram of the microprocessor of FIG. 2;

FIG. 4 is a graphic representation of a power control command signal;

FIG. 5 is a chart showing exemplary addresses and instructions which form power control command signals; and

FIG. 6 is a flow chart depicting operation of an exemplary embodiment of the microprocessor according to the present invention.

### DETAILED DESCRIPTION

The following description is presented to enable one of ordinary skill in the art to make and use the present invention as provided within the context of a particular application and its requirements. Various modifications to the preferred embodiment will, however, be apparent to those skilled in the art, and the general principles defined herein may be applied to other embodiments. Therefore, the present invention is not intended to be limited to the particular embodiments shown and described herein, but is to be accorded the widest scope consistent with the principles and novel features disclosed herein.

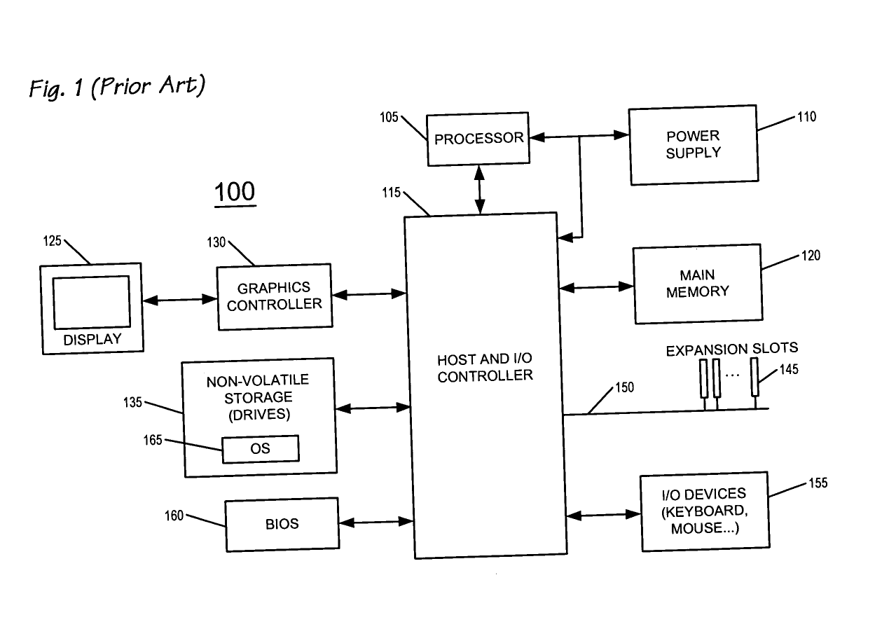

FIG. 1 is a block diagram of a conventional computer system 100 employing a microprocessor 105 wherein power management is conducted external to the processor 105. A power supply 110 is coupled to processor 105, host and I/O controller 115, and other components of system 100. The controller 115 couples the microprocessor 105 to main memory 120 and also to a display 125 via a graphics controller 130. Nonvolatile storage 135 such as disk drives or other media is coupled to the controller 115 to provide permanent storage for the system 100. Expansion slots 145 are coupled to the controller 115 via an expansion bus 150. I/O devices 155 such as a keyboard and mouse are coupled to the controller 115 as well. Basic Input Output System (BIOS) firmware 160 is coupled to the controller 115 to control the operation of the system 100 at the hardware level.

All of the devices described above consume power from the power supply 110. When the system 100 powers up (i.e., boots), the operating system (OS) 165 is loaded from nonvolatile storage 135 into main memory 120 under the direction of the BIOS 160. The operating system 165 is then executed by the microprocessor 105. In the example shown, the computer system 100 employs the aforementioned Advanced Configuration and Power Interface (ACPI) to enable the operating system to direct motherboard device configuration and power management. ACPI provides the operating system with an interface for engaging multiple processor power states to enable power conservation. Such power states include an active power state wherein the processor 105 executes instructions and further includes multiple sleep states wherein the processor 105 consumes less power and dissipates less heat than leaving the processor 105 in the active power state. When in the active power state, ACPI enables the performance of the processor 105 to be decreased in order to conserve power. In some alternative systems, a microcontroller external to the processor 105 has been used to manage power consumption under the direction of BIOS.

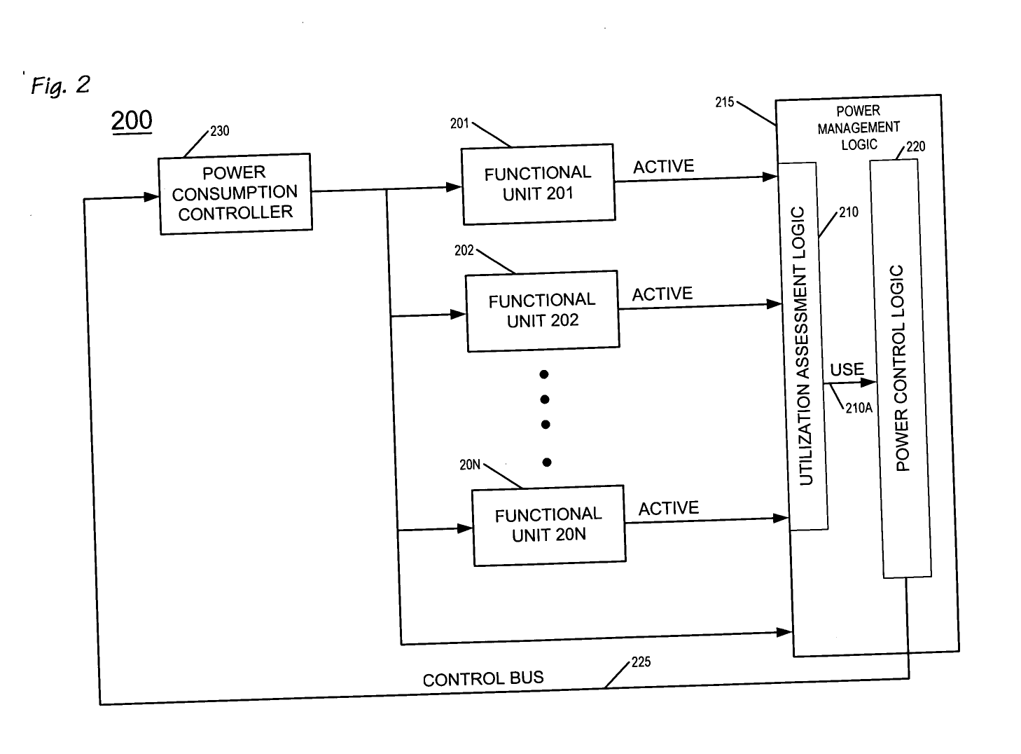

Now referring to FIG. 2, a block diagram is presented illustrating one embodiment of the present invention where power consumption by a microprocessor 200 is dynamically managed as a function of utilization of resources within the processor 200 and operational power profiles. In one embodiment, the utilization of power by various functional units within the microprocessor 200 is measured and processed to determine the processor's overall power consumption to a finer degree of resolution than has heretofore been provided.

The microprocessor 200 includes functional units 201-20N wherein N is the total number of functional units 201-20N. A functional unit 201-20N is logic, circuits, devices, or microcode (i.e., micro instructions or native instructions), or a combination of logic, circuits, devices, or microcode, or equivalent elements that are employed to perform a specified function. The elements employed to perform the specified function in a given functional unit may be shared with other circuits, microcode, etc., that are employed to perform other functions within other functional units 201-20N. For example, functional units 201-20N can be any functional units 201-20N of the microprocessor 200 such as the fetch unit, translator, register unit, address unit, execute unit, integer unit, floating point unit, MMX™, arithmetic logic unit, write back unit, branch prediction unit, various levels of internal cache, as well as other functional units 201-20N of the processor 200. In one embodiment, the functional units 201-20N each include an output signal ACTIVE which indicates that a respective functional unit 201-20N is active (i.e., enabled and performing its specified function) and consuming power. These output signals ACTIVE are alternatively referred to as “activity outputs.” In an alternative embodiment, the value of output signal ACTIVE indicates how much power that a respective functional unit 201-20N is consuming

The outputs ACTIVE (or activity outputs) of functional units 201-20N are coupled to respective inputs of utilization assessment logic 210 which resides in power management logic 215. The power management logic 215 is logic, circuits, devices, or microcode (i.e., micro instructions or native instructions), or a combination of logic, circuits, devices, or microcode, or equivalent elements that are employed to conducts power management activities for the microprocessor 200 as will now be set forth in more detail. In one embodiment, the power management logic 215 assesses the respective power consumption of the individual functional units 201-20N. The power management logic 215 also dynamically determines the total power consumption of the functional units 201-20N of the microprocessor 200 as such consumption varies over time. The total power consumption thus determined is referred to as the total power consumption value. Once the current total processor power consumption value of the functional units 201-20N is determined, the power management logic 215 takes action to decrease or increase power consumption by the functional units 201-20N if such action is found to be necessary. For example, if the total power consumption value of the functional units 201-20N at a particular point in time is determined to be more than a predetermined threshold value, then the power management logic 215 takes action to reduce power consumption by the functional units 201-20N. In carrying out this assessment and power control process, the amount of power consumed by the functional units 201-20N individually and collectively can be monitored and determined more accurately than has heretofore been provided for. Advantageously, with this approach there is no need to rely on coarse assessments of power consumption by logic or sensors external to the microprocessor 200.

In more detail, some or all of the functional units 201-20N of the microprocessor 200 are monitored to determine their power consumption. An alternative embodiment contemplates that a subset of the functional units 201-20N are monitored, however, one skilled in art will appreciate that the fidelity of the assessment of total power consumption by the microprocessor 200 is increased based upon the number of functional units 201-20N which are monitored. For convenience, the term total power consumption value is used for the sum total of power consumption of those functional units 201-20N which are measured in either case. It is not necessary that every single functional unit 201-20N be measured. However, it is desirable to measure as many functional units 201-20N as reasonably possible in a particular application.

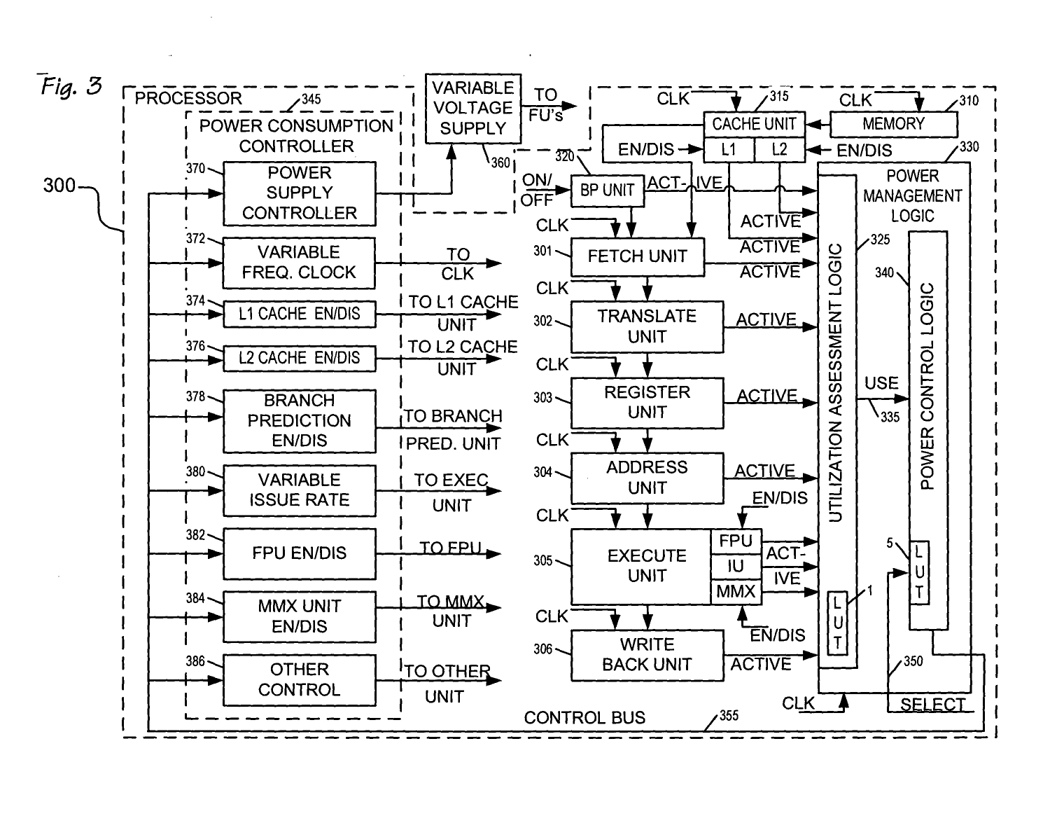

The utilization assessment logic 210 is logic, circuits, devices, or microcode (i.e., micro instructions or native instructions), or a combination of logic, circuits, devices, or microcode, or equivalent elements that are employed to assess power utilization of the functional units 201-20N. The utilization assessment logic 210 includes an output 210A at which a signal USE is generated to provide an indication of the amount of power that the functional units 201-20N are currently consuming. The mechanism by which the utilization assessment logic 210 provides the signal USE indicative of the amount of power presently consumed will be discussed later in more detail. In one embodiment, the signal USE includes the total power consumption value. The USE output 210A of the utilization assessment logic 210 is coupled to power control logic 220. In one embodiment, the power control logic 220 monitors the signal USE to determine when the signal USE indicates that more than a predetermined amount of power is being consumed by functional units 201-20N. If more than a predetermined amount of power is being consumed at a particular point in time, then the power control logic 220 generates an appropriate signal over a control bus 225 to instruct a power consumption controller 230 to decrease power consumption by any or all of functional units 201-20N of the microprocessor 200. One or more of the functional units 201-20N thus enter a power reduction mode. The mechanism by which the power control logic 220 acts in conjunction with the power consumption controller 230 to reduce processor power consumption will be discussed in more detail with reference to FIG. 3. Examples of power reduction modes by which the power consumption controller 230 decreases power consumption include decreasing the supply voltage to the processor, decreasing the clock frequency of the microprocessor 200, disabling internal cache, issuing instructions at a decreased rate, and disabling branch prediction. Alternative power reduction modes contemplate a combination of the aforementioned examples. Other components of the microprocessor 200 can also be disabled or utilized in a reduced capacity as well.

FIG. 3 is a more detailed block diagram of the microprocessor 200 discussed above with reference to FIG. 2. Similarities in nomenclature will be noted between the microprocessor 200 depicted in FIG. 2 and the microprocessor 300 depicted in FIG. 3. In one embodiment, the microprocessor 300 is a pipelined X86 architecture processor including the following functional units: fetch unit 301, translate unit 302, register unit 303, address unit 304, execute unit 305, and write back unit 306. In this embodiment, each of these functional units 301-306 includes an input to which a clock signal CLK is applied.

Each of the functional units 301-306 also includes an activity output (designated ACTIVE in the functional units 301-306 of FIG. 3) which provides an activity signal to show that the respective functional unit 301-306 is operating and consuming power in the manner as was previously described with reference to FIG. 2. In one embodiment, the activity signal at the ACTIVE output of a functional unit 301-306 indicates how active that particular functional unit 301-306 is and thus the activity signal gives a dynamic indication of how much power a particular functional unit 301-306 is consuming over time. In one embodiment, the activity signal is refreshed each clock cycle. Variations in power consumption of a functional unit 301-306 are observed in its respective activity signal. Alternatively, the activity signal, when refreshed, indicates whether a respective functional unit 301-306 is active (i.e., enabled and performing its specified function) or not. As will be explained in more detail later, some functional units 301-306 can be disabled or otherwise controlled to reduce power consumption and enabled or otherwise controlled to increase power consumption when power conservation is no longer needed.

A memory 310 is coupled via cache unit 315 to the fetch unit 301 as illustrated. The cache unit 315 includes an L1 and an L2 cache. The L1 cache in cache unit 315 includes an EN/DIS input (i.e., enable/disable) as shown such that the L1 cache can be disabled or otherwise directed to decrease performance as described above in order to reduce power consumption. Likewise, the L2 cache in the cache unit 315 includes an EN/DIS input (i.e., enable/disable) as shown such that the L2 cache can be disabled or otherwise directed to decrease performance as described above in order to reduce power consumption. When the L1 and L2 caches are enabled, they are capable of full performance according to specification.

The microprocessor 300 includes a branch prediction unit 320 which is coupled to the fetch unit 301. When the microprocessor 300 encounters a branch instruction in the program code that it is to execute, the branch prediction unit 320 provides the microprocessor 300 with a prediction as to whether the branch is taken or not taken. The branch prediction unit 320 increases the execution speed of processor 300; however, in some application scenarios it is not essential. In the microprocessor 300 of FIG. 3, the branch prediction unit 320 includes an EN/DIS input such that branch prediction can be disabled or otherwise controlled to decrease performance in order to reduce power consumption.

In one embodiment, the execute unit 305 includes an integer unit (IU), a floating point unit (FPU), and an MMX unit (MMX) for handling MMX instructions. The floating point unit FPU is not essential to the execution of program code although having an FPU increases the execution speed of the microprocessor 300 for certain applications. The floating point unit FPU includes an EN/DIS input such that it can be disabled or otherwise controlled to decrease performance in order to conserve power, or it can be enabled to increase efficiency with respect to floating point calculations. Likewise, the MMX unit (MMX) includes an EN/DIS input as well such that it can be disabled or otherwise controlled to decrease performance in order to conserve power.

As mentioned earlier, the fetch unit 301, translate unit 302, register unit 303, address unit 304, and write back unit 306 each have activity outputs (labeled ACTIVE), in one embodiment, which indicate that they are enabled and performing their specified functions or, in an alternative embodiment, which indicate the extent to which they are respectively consuming power. The execute unit 305 includes the aforementioned integer unit (IU), floating point unit (FPU), and MMX unit which each have an activity output (ACTIVE) to indicate power consumption activity in a similar manner as described above. All of these activity outputs (labeled ACTIVE) are coupled to utilization assessment logic 325, which is included within power management logic 330 as shown in FIG. 3. It is noted that in this particular microprocessor 300, the fetch unit 301, translate unit 302, register unit 303 and write back unit 306 do not have EN/DIS inputs such that they can be disabled or otherwise controlled to conserve power. These units are regarded as being essential to processor operation. However, as will be explained later in more detail, under control of power management logic 330, the clock rate and/or power supply voltage to these functional units 301-306 can be reduced to conserve power when certain activity levels or power consumption levels are reached. Reduced clock rate and reduced supply voltage are additional power reduction modes contemplated by the present invention.

The power management logic 330 monitors, assesses, and controls the consumption of power throughout the various functional units 301-306, 315, 320 of the microprocessor 300 as will now be discussed in more detail. The utilization assessment logic 325 monitors the activity signals from the aforementioned functional units 301-306, 315, 320. In this manner utilization assessment logic 325 is apprised of the amount of activity of each functional unit 301-306, 315, 320. In some cases, the amount of activity of a particular functional unit 301-306, 315, 320 corresponds closely to the power consumption of that functional unit 301-306, 315, 320. In other cases, a functional unit 301-306, 315, 320 consumes a fixed amount of power when enabled, whether it is performing its specified function or not. For purposes of discussion it is assumed that the microprocessor 300 has just been initialized and that all functional units 301-306, 315, 320 are enabled and consuming power. In this event all of the activity signals from the various functional units 301-306, 315, 320 will have values indicating activity. The higher the value of a functional unit's activity signal, the greater is the activity and corresponding power consumption of that functional unit 301-306, 315, 320.

In an exemplary embodiment, the utilization assessment logic 325 includes a look-up TABLE 1 (LUT 1) containing data relating the activity signal from each functional unit 301-306, 315, 320 to the corresponding power consumed by that functional unit 301-306, 315, 320. In this particular example, the activity signals each range from 1 to 10 in value with 1 representing the least amount of activity by a functional unit 301-306, 315, 320 and 10 representing the most activity by a functional unit 301-306, 315, 320. It is noted that different functional units 301-306, 315, 320 will consume different amounts of power. Thus, an activity signal value of “10” from one functional unit 301-306, 315, 320 will scale to one particular power consumption value whereas the same activity signal value of “10” from another functional unit 301-306, 315, 320 may scale to a different power consumption value depending on the maximum power consumption by each functional unit 301-306, 315, 320 when fully active.

TABLE 1
(LUT 1)

| | | CORRESPONDING |
|---|---|---|
| | ACTIVITY | POWER CONSUMPTION |
| | SIGNAL | VALUES |
| FUNCTIONAL UNIT | VALUES | (WATTS) |
| L1 Cache | 1-10 | 0.1-0.5 |
| L2 Cache | 1-10 | 0.1-1 |
| Branch Prediction | 1-10 | 0.1-1 |
| Unit | | |
| Fetch Unit | 1-10 | 0.2-2 |
| Translate Unit | 1-10 | 0.2-2 |
| Register Unit | 1-10 | 0.2-2 |
| Address Unit | 1-10 | 0.2-2 |
| Execute Unit (IU) | 1-10 | 0.1-2 |
| Execute Unit (FPU) | 1-10 | 0.1-2 |
| Execute Unit (MMX) | 1-10 | 0.1-1 |
| Write Back Unit | 1-10 | 0.2-2 |
| TOTAL | | 17.5 max |

The information shown in Table 1 is intended to show activity signal values and corresponding power consumption values for the functional units of an exemplary microprocessor 300. It should be appreciated that activity signal values and the corresponding power consumption values of each functional unit 301-306, 315, 320 will vary from processor to processor in actual practice. In one embodiment, these activity signal values and corresponding power consumption values of the functional units 301-306, 315, 320 are predetermined by analysis and measurement before the look-up table is populated with data. In one embodiment, look-up TABLE 1 will include power consumption values across the full range of 1-10 activity signal values. For example, the portion of look-up TABLE 1 relative to the L2 cache would appear as follows in TABLE 2.

TABLE 2
(L2 cache)

| | ACTIVITY | CORRESPONDING |
|---|---|---|
| FUNCTIONAL | SIGNAL | POWER CONSUMPTION |
| UNIT | VALUE | VALUES (WATTS) |
| L2 Cache | 1 | .1 |
| L2 Cache | 2 | .2 |
| L2 Cache | 3 | .3 |
| L2 Cache | 4 | .4 |
| L2 Cache | 5 | .5 |
| L2 Cache | 6 | .6 |
| L2 Cache | 7 | .7 |
| L2 Cache | 8 | .8 |
| L2 Cache | 9 | .9 |
| L2 Cache | 10 | 1.0 |

In a similar manner, the portion of look up TABLE 1 relative to fetch unit 301 would appear as follows in TABLE 3:

TABLE 3
(Fetch Unit)

| | | CORRESPONDING |
|---|---|---|
| FUNCTIONAL | ACTIVITY | POWER CONSUMPTION |
| UNIT | SIGNAL VALUE | VALUES (WATTS) |
| Fetch Unit | 1 | .2 |
| Fetch Unit | 2 | .4 |
| Fetch Unit | 3 | .6 |
| Fetch Unit | 4 | .8 |
| Fetch Unit | 5 | 1.0 |
| Fetch Unit | 6 | 1.2 |
| Fetch Unit | 7 | 1.4 |
| Fetch Unit | 8 | 1.6 |
| Fetch Unit | 9 | 1.8 |
| Fetch Unit | 10 | 2.0 |

It is noted that some functional units 301-306, 315, 320 are capable of being controlled in order to decrease power consumption while others simply are disabled.

Since the activity signal of each functional unit 301-306, 315, 320 is provided to utilization assessment logic 325 and this logic 325 determines the corresponding current power value consumed by each functional unit 301-306, 315, 320 by virtue of the look-up TABLE 1, the utilization assessment logic 325 is able to dynamically and more accurately determine the total power consumption of the microprocessor 300 from clock cycle to clock cycle. This is possible because, in one embodiment, the activity signals are updated by each functional unit 301-306, 315, 320 from clock cycle to clock cycle. An alternative embodiment contemplates that the activity signals are updated every N clock cycles, where N is an integer from 1 to 1000.

In more detail, the utilization assessment logic 325 receives activity signals from the respective functional units 301-306, 315, 320 and looks up in TABLE 1 the power consumption value corresponding to the activity signal from each functional unit301-306, 315, 320. This yields a plurality of power consumption values with each power consumption value corresponding to a different functional unit 301-306, 315, 320. The utilization assessment logic 325 aggregates all of these power consumption values from the individual functional units 301-306, 315, 320 together to determine a total power consumption value. The utilization assessment logic 235 continuously determines the total power consumption value and reports the result on USE bus 335.

To more fully appreciate how the utilization assessment logic 325 determines the total power consumption value that it reports on USE bus 335, an example will now be discussed. However, first it should be recalled that those functional units having an EN/DIS input can be disabled to reduce power consumption. This applies to the L1 and L2 caches, branch prediction unit 320, the floating point unit (FPU) and MMX unit of execute unit 305 in this particular embodiment. The remaining functional units, namely fetch unit 301, translate unit 302, register unit 303, address unit 304, the integer unit (IU) of execute unit 305 and write back unit 306 consume varying amounts of power as indicated by their respective activity signals and must be controlled to reduce power consumption by alternative techniques described above. It is noted that the present invention comprehends various other techniques extant within the art for controlling the power consumption of the remaining functional units 301-306 such as changing core clock frequency, changing core logic voltage, and instruction staggering, i.e., allowing instruction progression every N clock signals, where N is an integer from 1 to 100.

For purposes of this example, it is assumed that the microprocessor 300 has just been initialized and that all functional units 301-306, 315, 320 are enabled. Thus, all functional units 301-306, 315, 320 are drawing power and will generate a respective activity signal so indicating at their activity outputs (labeled ACTIVE). More specifically, the functional units 301-306, 315, 320 will generate the following activity signal values shown in TABLE 4 signifying that each functional unit 301-306, 315, 320 is active and consuming power.

TABLE 4
Processor Initialized and Functional Units Fully Active

| | | CORRESPONDING | |
|---|---|---|---|
| | ACTIVITY | POWER CONSUMPTION | |
| | SIGNAL | VALUE RETRIEVED | |
| | VALUE | FROM LOOK-UP TABLE 1 | |
| FUNCTIONAL UNIT | OBSERVED | (WATTS) | |
| L1 Cache | 10 | 0.5 | |
| L2 Cache | 10 | 1 | |
| Branch Prediction Unit | 10 | 1 | |
| Fetch Unit | 10 | 2 | |
| Translate Unit | 10 | 2 | |
| Register Unit | 10 | 2 | |
| Address Unit | 10 | 2 | |
| Execute Unit (IU) | 10 | 2 | |
| Execute Unit (FPU) | 10 | 2 | |
| Execute Unit (MMX) | 10 | 1 | |
| Write Back Unit | 10 | 2 | |
| TOTAL | | 17.5 | watts |

The utilization assessment logic 325 is provided with the 11 above activity signals each having a value of 10. Logic 325 then determines the corresponding power consumption value for each functional unit, namely the values 0.5, 1, 1, 2, 2, 2, 2, 2, 2, 1, and 2 and aggregates all of these values to obtain a total of 17.5 watts as the total power consumption value for the microprocessor 300. The total power consumption value of 17.5 is supplied to the power control logic 340 over USE bus 335. It is noted that this is a dynamic calculation and can be rapidly repeated as frequently or infrequently as desired.

The power control logic 340 takes action to reduce the consumption of power by the functional units 301-306, 315, 320 if the total power consumption value reported on USE bus 335 exceeds a predetermined threshold level set in accordance with a selected power profile stored in power control logic 340. In an exemplary embodiment, power control profiles are stored in a look-up TABLE (LUT) 5 in the power control logic 340. Exemplary look-up TABLE 5 includes several power profiles with corresponding power consumption thresholds. If the current total power consumption value on USE bus 335 exceeds a selected power profile threshold from TABLE 5, this will trigger a power reduction action by power control logic 340.

TABLE 5
(LUT 5)

| | THRESHOLD |
|---|---|
| POWER PROFILE | (Watts) |
| AC MAINS POWER | 18 |
| DOCKED | 18 |
| PORTABLE - STANDARD | 11 |
| PORTABLE - WIRELESS | 10 |
| PRESENTATION | 15 |
| MAXIMUM BATTERY LIFE | 8 |
| MINIMAL POWER MGMT | 15 |
| PORTABLE AIRLINE - WITH SEAT POWER | 18 |
| PORTABLE AIRLINE - WITHOUT SEAT POWER | 10 |
| AUTOMOBILE - WITH POWER INVERTER | 18 |
| AUTOMOBILE - W/O POWER INVERTER | 18 |

A detailed example will now be discussed. The power control logic 340 includes a SELECT input 350 on which a SELECT signal is provided to select which particular power profile the user desires. For example, if the user desires AC Mains power operation or docked operation, such that external power is freely available, then an appropriate SELECT signal is provided to SELECT input 350 instructing power control logic 340 to employ the 18 watt threshold as per look-up TABLE 5. The power control logic 340 determines if the current total power consumption value exceeds the 18 watts of the current selected profile. In this example, with all functional units 301-306, 315, 320 active, the current total power consumption value determined by utilization assessment logic 325 is found to be 17.5 watts. In this event, since the 17.5 watt current power consumption value indicated on use bus 335 does not exceed the 18 watt threshold of the selected AC MAINS power profile, power control logic 340 takes no action to reduce power consumption.

If however the SELECT signal at SELECT input 350 indicates that the PORTABLE—STANDARD power profile is selected (see TABLE 5 above) then an 11 watt threshold is employed by power control logic 340. In this instance, the functional units 301-306, 315, 320 of the newly initialized microprocessor 300 are again found by utilization assessment logic 325 to be consuming 17.5 watts. The power control logic 340 finds that the 17.5 watt current total power consumption value exceeds the 11 watt threshold of the selected PORTABLE—STANDARD power profile. In response, the power control logic 340 takes one or more of several different power reduction actions. In one embodiment, the power control logic 340 is configured to disable one or more of the microprocessor's non-essential functional units to reduce power until the power consumed by the functional units 301-306, 315, 320, as indicated by the current total power consumption value, is less than the threshold associated with the selected power profile from TABLE 5.

To achieve this power reduction, the power control logic 340 sends a control command over control bus 355 to instruct the power consumption controller 345 to commence power reduction actions. In the particular embodiment shown in FIG. 3, there are 6 functional units that can be disabled to reduce power consumption, namely the L1 and L2 caches of cache init 315, branch prediction unit 320, the FPU and MMX units of execute unit 305 and write back unit 306. It is also noted that variable voltage power supply 360 can be instructed to reduce the power supply voltage for the functional units 301-306, 315, 320 of the processor from one voltage to another lower voltage to conserve power. Moreover, the rate at which the functional units and other components of the processor 300 are clocked can be reduced from a first clock frequency to a lesser second clock frequency to lessen power consumption by the processor 300. Further, the rate at which instructions are issued for execute unit 305 to execute can be reduced by variable rate issue control 380 to lessen the power consumed by processor 300.

In more detail, the power consumption controller 345 includes a power supply control unit 370 coupled to variable voltage supply 360, a variable frequency clock control unit 372 having a CLK output coupled to the CLK inputs of the processor 300, an L1 cache control unit 374 coupled to the EN/DIS input of the L1 cache in cache unit 315, an L2 cache control unit 376 coupled to the EN/DIS input of the L2 cache in cache unit 315, a branch prediction control unit 378 coupled to the EN/DIS input of branch prediction (BP) unit 320, a variable rate issue control unit 380 coupled to execute unit 305, a floating point unit (FPU) control unit 382 coupled to the EN/DIS input of the floating point unit (FPU) in execute unit 305, and an MMX control unit 384 coupled to the EN/DIS input of the MMX unit of execute unit 305. The power consumption controller 345 also includes an “other control unit” 386 to signify that the disclosed technology is adaptable and may be applied to control other functional units and processor components in addition to those specifically discussed in this example.

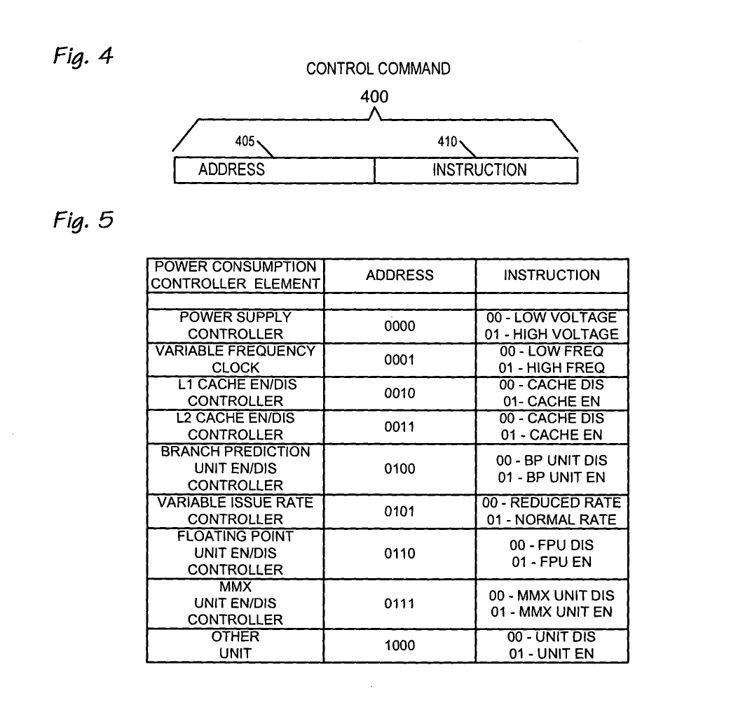

The format of an exemplary control command 400 is shown in FIG. 4. It will be recalled that each control unit is associated with a respective functional unit or other processor component which it is to control. The control command 400 includes an address 405 of one of the control units followed by an instruction 410 to be applied to the functional unit or component associated with the addressed control unit. Each of the power consumption controller elements, or control units 370, 372, 374, 376, 378, 380, 382, 384 and 386, has a unique address associated therewith as shown in FIG. 5.

By way of example, if the power control logic 340 determines that the selected threshold has been exceeded, then it starts issuing commands to disable or otherwise control the performance of functional units until the power consumed by the functional units as reflected by the current total power consumption value is less than the selected threshold. In addition to the above described power reduction action, the power control logic 340 can also issue commands to cause the power supply voltage to be reduced and the clock speed to be reduced, both actions saving substantial power.

More specifically, to reduce power consumption of the microprocessor 300 when the current total power consumption value is found to exceed the selected threshold, the power control logic 340 sends a command to the power supply controller 370 telling it to instruct the variable voltage supply 360 to reduce its output supply voltage from a first high voltage, say 5 volts, to a second lower voltage, say 3.3 volts. The output supply voltage is provided to the functional units and other components of the processor as indicated by the arrow at the output of controller 370 designated “TO FU's” in FIG. 3. More particularly, with reference to the power supply controller row of FIG. 5, power control logic 340 sends a command signal having an address 0000 and an instruction 00. 0000 is the unique address that corresponds to power supply controller 370. This command is sent over the control bus 355. Power supply control unit 370 recognizes the 0000 address as being a command for which it is to take the action prescribed by the 00 command, namely to switch variable voltage power supply 360 to a lower voltage state to conserve power. It is noted that reducing the supply voltage need not be the first power reduction action taken when the selected threshold is found to be exceeded. Any other of the eight power consumption controller elements listed in FIG. 5 could be addressed as well to cause the microprocessor 300 to enter one of corresponding eight power reduction modes in this particular example.

The power control logic 340 continues to monitor to determine if the power presently being consumed by the functional units 301-306, 315, 320 of the processor is less than the selected threshold. If the voltage reduction action described above was sufficient to reduce power consumption to below the selected threshold, then the microprocessor 300 can continue operating with power control logic 340 taking no more action to further reduce power consumption. However, if the supply voltage reduction action was not sufficient to cause power consumption to drop below the selected threshold, then the power control logic 340 continues instructing functional units 301-306, 315, 320 to reduce power consumption.

For example, the power control logic 340 sends a command to variable frequency clock 372 telling it to reduce the clock frequency at the clock inputs (CLK) of the processor from a first frequency, say 2 GHz, to a lower frequency, say 1 GHz. More particularly, with reference to the variable frequency clock controller row of FIG. 5, the power control logic 340 sends a command signal having an address 0001 and an instruction 00. 0001 is the unique address that corresponds to variable frequency clock 372. This command signal is sent over the control bus 355. Variable frequency clock 372 recognizes the 0001 address as being a command for which it is to take the action prescribed by the 00 command, namely to switch from a high frequency clock rate to a lower frequency clock rate. The resultant reduced frequency clock signal is applied to the clock inputs CLK of components of the microprocessor 300 of FIG. 3 as illustrated.

For discussion purposes it is assumed that the additional power reduction achieved by reducing the clock rate is still insufficient to drop the consumption of power by the microprocessor 300 to less than the selected threshold as determined by power control logic 340 which is updated with activity signal information from the functional units 301-306, 315, 320. Thus further power conservation efforts are still necessary. In this event, the power control logic 340 sends a command to the L1 cache EN/DIS controller 374 telling it to disable the L1 cache of the cache unit 315. More particularly, with reference to the L1 cache ON/OFF controller row of FIG. 5, the power control logic 340 sends a command signal having an address 0010 and an instruction 00. 0010 is the unique address that corresponds to L1 cache EN/DIS controller 374. The L1 cache EN/DIS controller 374 recognizes the 0010 address as being a command for which it is to take the action prescribed by the 00 command, namely to switch from an enabled state which consumes substantial power to disabled state which consumes little or minimal power. The L1 cache of cache unit 315 is thus controlled to conserve power.

In this example, it is assumed that with the last power reduction action above, the power consumed by the functional units 301-306, 315, 320 of the microprocessor 300 as indicated by the current total power consumption value is now less than the selected threshold of the desired power profile. This is detected by the power control logic 340 which takes no further action to reduce power consumption since the demands of the current power profile and the associated selected threshold have been met. In this example, three separate power reduction actions were taken and three power reduction modes were entered. Many other power reduction actions can be taken by power control logic 340 as indicated by the list of commands (FIG. 5) that can be issued thereby. Once skilled in the art will appreciate that these power reduction commands can be given in a varied order or sequence, not just the sequence suggested in the above example. For example, the first power reduction mode to be entered could be turning the L1 cache unit off and the second power reduction mode could be disabling the L2 cache. Moreover, more power reduction actions can be taken than the three actions described in this example. It is conceivable to implement all eight power reduction modes simultaneously operative to reduce power consumption to the greatest extent possible in this example.

Even though the power consumption of the microprocessor 300 is already reduced as described above, the power control logic 340 continues to monitor signal USE 335 to determine if power consumption should start to again exceed the selected threshold. This could occur if different types of instructions are encountered or if the power profile is changed to one with a lower threshold. An example of a power profile with a lower threshold is seen in TABLE 5 above wherein the PRESENTATION mode has a 15 watt threshold. With this threshold now selected, the threshold has been reduced from the earlier described 18 watt threshold associated with the AC MAINS power mode. Thus, if utilization assessment logic 325 now reports over USE bus 335 a current total power consumption value of for example 16 watts, then power control logic 340 will perform a comparison of the present 16 watt power consumption with the 15 watt selected threshold and find that the threshold is exceeded. Further power reduction is now necessary.

In this event, the power control logic 340 sends a command to the L2 cache EN/DIS controller 376 telling it to disable the L2 cache of cache unit 315. More particularly, with reference to the L2 cache EN/DIS controller row of FIG. 5, the power control logic 340 sends a command signal having an address 0011 and an instruction 00. 0011 is the unique address that corresponds to L2 cache EN/DIS controller 376. The L2 cache EN/DIS controller 376 recognizes the 0011 address as being a command for which it is to take the action prescribed by the 00 command, namely to switch from an enabled state which consumes substantial power to a disabled state which consumes little or minimal power.

At this point, it is noted that the supply voltage has been reduced, the clock rate has been reduced, the L1 cache has been disabled. For purposes of example, it is assumed that the power control logic 340 finds that even with the four above-described power reduction actions, the 15 watt threshold of the selected PRESENTATION power profile is still exceeded such that further power reduction is necessary. In response to this finding, the power control logic 340 takes further action. The power control logic 340 sends a command to the branch prediction EN/DIS controller 378 telling it to disable branch prediction unit 320. More particularly, with reference to the branch prediction unit controller row of FIG. 5, the power control logic 340 sends a command signal having an address 0100 and an instruction 00. 0100 is the unique address that corresponds to branch prediction unit controller 378. Branch prediction unit controller 378 recognizes the 0100 address as being a command for which it is to take the action prescribed by the 00 command, namely to switch from an enabled state which consumes substantial power to a disabled state which consumes little or minimal power.

Power control logic 340 again performs a comparison and finds that the reduced power of 14 watts, the new current total power consumption value, is now less than the selected threshold of 15 watts. Thus, the power control logic 340 thus initiates no further power reduction actions at this time; however it continues to monitor to see if power consumption continues to be less than the selected threshold.

It is noted that should further power consumption reductions be necessary, the power control logic 340 can control other functional units 301-306, 315, 320 in addition to those already discussed above. For example, the power control logic 340 can instruct the variable issue rate controller 380 to command execute unit 305 to execute instructions at a slower rate, for example, every second clock cycle instead of every clock cycle, or every third clock cycle, or every fourth clock cycle, for example. To further reduce power consumption, the power control logic 340 can also command MMX unit EN/DIS controller 384 to disabled the MMX unit. The power consumption control unit 370 includes an “other control” controller 386 so that other functional units and components not depicted in FIG. 3 can be controlled to reduce power consumption. For example, the other controller 386 may be employed to disabled a reorder buffer and engage only a register file in a superscalar processor to cause such a processor to revert to in-order execution with a concurrent savings in power.

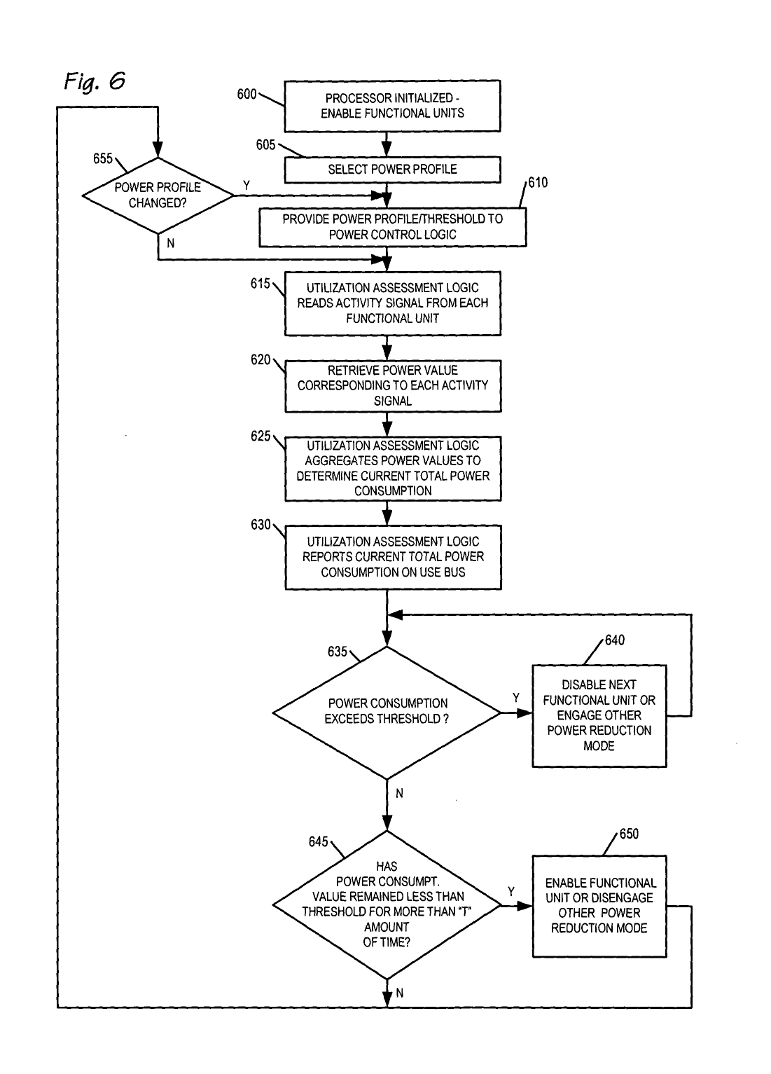

Now turning to FIG. 6, a flow diagram is presented depicting an exemplary process flow carried out by microprocessor 300 of FIG. 3 as it conducts power conservation operations. The microprocessor 300 is initialized as per block 600. When initialized, all functional units of the processor are enabled. The power control logic 340 sends a series of commands to the functional units, namely by sending each functional unit's address followed by the 01 instruction of FIG. 5. In this manner, each functional unit knows that it should be enabled for processor operations to begin. Flow then proceeds to block 605.

At block 605, a power profile is selected 605. The power profile can be stored within the microprocessor 300 or can be provided via communication means such as memory, serial ports, external pins, JTAG inputs, etc. Flow then proceeds to block 610.

At block 610, the power profile is provided to power control logic 340. More specifically, the power threshold corresponding to the selected power profile (one example of which is illustrated in TABLE 5) is provided to power control logic 340. This threshold is the selected threshold. Flow then proceeds to block 615.

At block 615, utilization assessment logic 325 reads the activity signals at the activity outputs of the functional units to check their activity, and hence their power consumption. Since the microprocessor has just been initialized, all of the activity outputs will show activity since no functional units are initially disabled in this particular embodiment. Flow then proceeds to block 620.

At block 620, the utilization assessment logic 325 accesses a predetermined power consumption value corresponding to each activity signal read from the functional units, an example of which is illustrated with reference to lookup TABLE 1. Flow then proceeds to block 625.

At block 625, the utilization assessment logic 325 sums the retrieved power consumption values together to determine a current total power consumption. Flow then proceeds to block 630.

At block 630, the current total power consumption value is provided on USE bus 335 as the USE signal to power control logic 340. Flow then proceeds to decision block 635.

At decision block 635, the power control logic 340 compares the present power consumption, indicated by the total power consumption value on USE bus 335, with the threshold in the currently specified power profile. If power control logic 340 determines that the current total power consumption value exceeds the threshold, then flow proceeds to block 640. If not, then flow proceeds to decision block 645.

At block 640, the power control logic 340 sends a command to one of the controllers 374, 376, 378, 380, 382, 384 instructing that controller to reduce the power consumption by the respective functional unit that it controls. Power reduction can also be achieved through other power reduction modes such as power control logic 340 issuing a command to power supply controller 370 instructing it to decrease the supply voltage to the processor, or issuing a command to variable frequency clock controller 372 instructing it to reduce the clock frequency of the processor. Flow then proceeds to decision block 635.

It is noted that decision block 635 will keep disabling additional functional units or engaging other power reduction modes until the present power consumption no longer exceeds the threshold specified in the selected power profile.

It is desirable to have the microprocessor 300 operate at the maximum efficiency allowable within the confines of the selected power profile. The instructions being executed by the microprocessor may change over time such that the power consumption profile of the functional units changes. In addition, a different power profile may be selected or engaged over the course of a mission which is more or less restrictive on power consumption. For these reasons, decision block 645 performs a test to determine if the current total power consumption value exhibited by the microprocessor remains less than the selected threshold for more than a time, T, for example, 1 minute. If power consumption is found to be less than the threshold for such an amount of time, then flow proceeds to block 650. If not, then flow proceeds to decision block 655.

At block 650, one of the functional units that was previously disabled is enabled or another power reduction mode that was previously engaged is disengaged. To achieve this, power control logic 340 sends a command including a controller address and instruction to one of the controllers within power consumption controller 345 to cause a functional unit to be enabled or another power management mode to be disengaged. Flow then proceeds to decision block 655.

A test is then conducted at decision block 655 to determine if the power profile has been changed. If the power profile has not been changed then process flow is directed to block 615 at which utilization assessment logic 325 reads the activity signals from the functional units as has been previously discussed. Processing flow then continues as before with power control logic 340 again evaluating whether or not the current total power consumption value exceeds the selected threshold. However, if in decision block 655 it is determined that the power profile has changed, then process flow is directed to block 610 where the new selected power profile is provided to power control logic 340 for future use. Processing flow then continues as before with power control logic 340 again evaluating whether or not the current power consumption by the functional units exceeds the newly selected threshold.

Advantageously, the disclosed microprocessor mechanism controls its own efficiency and power consumption according to a specified power profile. The microprocessor examines its own internal power consumption and controls its functional units as a function of the selected power profile and the aggregated individual power consumption values of its functional units.

Although the present invention and its objects, features, and advantages have been described in detail, other embodiments are encompassed by the invention. In addition to implementations of the invention using hardware, the invention can be embodied in computer readable program code (e.g., software) disposed, for example, in a computer usable (e.g., readable) medium configured to store the code. The code causes the enablement of the functions, fabrication, modeling, simulation and/or testing, of the invention disclosed herein. For example, this can be accomplished through the use of computer readable program code in the form of general programming languages (e.g., C, C++, etc.), GDSII, hardware description languages (HDL) including Verilog HDL, VHDL, AHDL (Altera Hardware Description Language) and so on, or other databases, programming and/or circuit (i.e., schematic) capture tools available in the art. The code can be disposed in any known computer usable medium including semiconductor memory, magnetic disk, optical disc (e.g., CD-ROM, DVD-ROM, etc.) and as a computer data signal embodied in a computer usable (e.g., readable) transmission medium (e.g., carrier wave or any other medium including digital, optical or analog-based medium). As such, the code can be transmitted over communication networks including the Internet and intranets. It is understood that the functions accomplished and/or structure provided by the invention as described above can be represented in a processor that is embodied in code (e.g., HDL, GDSII, etc.) and may be transformed to hardware as part of the production of integrated circuits. Also, the invention may be embodied as a combination of hardware and code.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

1. An apparatus, for managing power consumption of a microprocessor comprising:
a plurality of functional units each including a corresponding plurality of activity outputs, for indicating when a respective functional unit is enabled;
utilization assessment logic, coupled to said plurality of activity outputs, for assessing activity thereof to determine a current total power consumption value for the microprocessor;
power control logic, coupled to said utilization assessment logic, for comparing said current total power consumption value with a threshold power value included in a specified power profile; and
a power consumption controller, coupled to said power management logic and said plurality of functional units, for engaging one of a plurality of power reduction modes if said current total power consumption value exceeds said threshold power value.

2. The apparatus as recited in claim 1, wherein one of said plurality of functional units is a cache and one of said plurality of power reduction modes is disabling said cache.

3. The apparatus as recited in claim 1, wherein one of said plurality of functional units is a branch prediction unit and one of said plurality of power reduction modes is disabling said branch prediction unit.

4. The apparatus as recited in claim 1, wherein one of said plurality of functional units is a floating point unit and one of said plurality of power reduction modes is disabling said floating point unit.

5. The apparatus as recited in claim 1, wherein one of said plurality of functional units is an MMX unit and one of said plurality of power reduction modes is disabling said MMX unit.

6. The apparatus as recited in claim 1, wherein one of said plurality of functional units is an execute unit and one of said plurality of power reduction modes is controlling power consumption of said execute unit by reducing a rate of issue of instructions to said execute unit.

7. The apparatus as recited in claim 1, further comprising a clock of predetermined frequency coupled to said plurality of functional units, wherein one of said plurality of power reduction modes comprises reducing the frequency of said clock.

8. The apparatus as recited in claim 1, further comprising a power supply voltage controller for controlling a supply voltage applied to said plurality of functional units, wherein one of said plurality of power reduction modes comprises reducing said supply voltage.

9. A microprocessor power management mechanism, comprising:
a plurality of functional units, each including an activity output for indicating when a respective functional unit is enabled;
power management logic, coupled to said activity outputs of the functional units, for assessing the activity of individual functional units to determine a current total power consumption value for a microprocessor; and
a power consumption controller, coupled to said power management logic and said plurality of functional units, for disabling or reducing the power consumption of at least one of said plurality of functional units, if said current total power consumption value exceeds a threshold power value.

10. The microprocessor power management mechanism as recited in claim 9, further comprising a control bus coupled between said power management logic and said power consumption controller.

11. The microprocessor power management mechanism as recited in claim 10, wherein said power control logic sends a command over said control bus to instruct said power consumption controller to disable a first one of said plurality of functional units if said current total power consumption value exceeds said threshold power value.

12. The microprocessor power management mechanism as recited in claim 10, wherein said power control logic sends a command over said control bus to instruct said power consumption controller to disable more than one of said plurality of functional units if said current total power consumption value exceeds said threshold power value.

13. The processor of claim 10 wherein said power management logic comprises:
utilization assessment logic, for processing activity output signals from said respective activity outputs to determine said current total power consumption value.

14. A method for managing power consumption in a microprocessor, the microprocessor including a plurality of functional units, the method comprising:
prescribing a power profile for the microprocessor, the power profile having a threshold power value;
assessing activity of the individual functional units to determine a current total power consumption value for the microprocessor;
comparing the current total power consumption value with the threshold power value; and
if the current total power consumption value exceeds the threshold power value, engaging one of a plurality of power reduction modes.

15. The method as recited in claim 14, wherein one of the plurality of power reduction modes includes disabling a first functional unit, the first functional unit being one of the plurality of functional units.

16. The method as recited in claim 15, wherein the first functional unit is a cache.

17. The method as recited in claim 15 wherein the first functional unit is a branch prediction unit.

18. The method as recited in claim 15, wherein the first functional unit is a floating point unit.

19. The method as recited in claim 15, wherein the first functional unit is an MMX unit.

20. The method as recited in claim 14, wherein said engaging comprises:
reducing a rate of issue of instructions to one or more of the plurality of functional units.

21. The method as recited in claim 14 wherein said engaging comprises:
reducing the frequency of a core clock within the microprocessor.

22. The method of claim 14, wherein said engaging comprises:
reducing an internal supply voltage from a first voltage to a second voltage.
